(19) United States
(12) Patent Application Publication
(10) Pub. No.: US 2012/0000367 A1
(43) Pub. Date: Jan. 5, 2012

(54) Brewery Facility for Producing and Bottling Beer

(76) Inventors: Rudolf Michel, Bamberg (DE); Ludwig Scheller, Ettringen (DE)

(21) Appl. No.: 13/256,869

(22) PCT Filed: Mar. 2, 2010
(86) PCT No.: PCT/DE2010/000227

§ 371 Date: Sep. 15, 2011

(30) Foreign Application Priority Data
Mar. 19, 2009 (DE) 10 2009 013 579.0

(51) Int. Cl. C12C 11/00

(52) U.S. Cl. 99/276

(57) ABSTRACT

The invention relates to a brewery plant (12) for producing and bottling beer, comprising a brewhouse facility (01) in which wort is produced from raw materials while employing process energy, and further comprising a bottling facility (02) in which beer produced from the wort is filled into packaging containers, in particular bottles, while employing process energy, wherein in order to supply the brewhouse facility (01) with process energy a first energy supply network (16) is provided, into which process heat having a first temperature level is fed from at least one first energy generation facility (17) and is distributed by a heat transfer means to different energy consumers (14, 15) in the brewhouse facility (01), and wherein in order to supply the bottling facility (02) with process energy a second energy supply network (21) is provided, into which process heat having a second temperature level is fed from at least one second energy generation facility (22) and is distributed by a heat transfer means to different energy consumers (23, 24, 25) in the bottling facility (02), wherein the maximum temperature of the heat transfer means in the first energy supply network is above the maximum temperature of the heat transfer means in the second energy supply network.

The present invention relates to a brewery plant for producing and bottling beer according to the preamble of claim 1.

Brewery plants are typically composed of several plant sections in order to enable in the different plant sections the gradual production firstly of the wort from the raw materials, subsequently the fermentation of the wort to produce beer, and ultimately the bottling of the ready-to-drink beer. To enable all of these different partial processes, all plant sections require process energy. With respect to the invention to be described in the following, the only plant sections which are of particular interest among the whole of the different plant sections of a brewery plant are the brewhouse facility for producing the wort and the bottling facility for filling the beer into bottles. However, the entire brewery plant may naturally also comprise further plant sections.

The invention relates to the supply of energy to a brewery plant with maximum efficiency and in this regard in particular to the especially efficient supply of process heat to the brewery plant, since a particularly large amount of process heat is required in the brewhouse facility in the mashing process, in particular in the mash boiling process and in the wort preparation process, in particular in the wort boiling process. By the same token, a relatively large amount of process heat is consumed in the brewery plant in the process of filling the beer into bottles and in all partial processes involved therein, in particular in the bottle cleaning process and in the pasteurizing process.

In the known brewery plants for supplying the brewhouse facility and the bottling facility with process heat provision is made for a central energy supply network, in which a heat transfer means, for instance steam and/or high temperature water, circulates and thereby supplies the different plant sections with the respectively required process heat. For to feeding the required process heat into the central energy supply network provision is here typically made for a thermal power plant, in which fossil fuels are combusted and the heat transfer means in this process is heated to the necessary temperature level.

Such a brewery plant having a central energy supply network for supplying all plant sections with process heat has the disadvantage that the different temperature levels at which the process heat is required in the different plant sections are not taken into account. In other words this means that the entire process heat needs to be fed into the central energy supply network with an energy density resulting from the partial process with the highest maximum temperature. If, for instance, a partial process in the brewery plant necessitates a temperature of the heat transfer means of 165° C., the entire process heat required in the brewery plant needs to be fed in with an energy density corresponding to said maximum temperature. Using a large number of energy generation methods for operating a brewery plant was thereby impracticable, since in many energy generation methods, in particular in alternative energy generation methods, such a high energy density with a correspondingly high maximum temperature level cannot be attained.

Departing from this state of the art it is hence an object of the present invention to suggest a novel brewery plant for producing and bottling beer, in which the utilization of fossil fuels to generate process heat is enabled with the aid of alternative energy generation methods. This object is attained by a brewery plant according to the teaching of claim 1.

Advantageous embodiments of the invention are the subject-matter of the subclaims.

The present invention is based on the analysis of the temperature level for implementing the different partial processes in the brewhouse facility and in the bottling facility. In this context, it has been recognized that the maximum temperature level of the partial processes of the brewhouse facility is much higher than the maximum temperature level of the partial processes in the bottling facility. The part of the process heat for operating the bottling facility thus can be fed in with a much lower energy density and hence using other energy generation methods, compared to the process heat for operating the partial processes in the brewhouse facility. According to the invention, in the brewery plant thus provision is made for a first energy supply network for supplying the brewhouse facility with process energy in the form of process heat, whereas provision is also made for a second energy supply network for supplying the bottling facility with process energy in the form of process heat. In this process, in each of the two energy supply networks a heat transfer means circulates, for instance hot water or steam. Said heat transfer means for the two energy supply networks are each heated separately from one another in different energy generation facilities, which are each assigned to the two energy supply networks, and are then distributed to the different energy consumers in the brewhouse facility, respectively to the different energy consumers in the bottling facility, by means of circulating the heat transfer means. Since the first energy supply network is separated from the second energy supply network, the process heat required for the bottling facility can be fed into the second energy supply network with a lower energy density. According to the invention provision is therefore made for the maximum temperature of the heat transfer means in the first energy supply network to be above the maximum temperature of the heat transfer means in the second energy supply network. By means of separating the temperature level in the brewhouse facility on the one hand and in the bottling facility on the other hand, it is subsequently possible to generate the entire process heat required for operating the bottling facility with a correspondingly lower energy density, i.e. with a correspondingly lower temperature, and to feed the same into the second energy supply network. Only the residual demand of process heat remaining for operating the brewhouse facility to needs to be generated with a correspondingly high energy density, such that a correspondingly smaller amount of the overall demand of process heat in the brewery plant needs to be generated with the correspondingly high energy density and needs to be distributed via the first energy supply network.

The maximum temperature of the heat transfer means in the first energy supply network, respectively in the second energy supply network, is basically optional and needs to be adapted to the respective requirements in the different partial processes of the brewhouse facility and the bottling facility, respectively. According to a preferred embodiment, the heat transfer means in the first energy supply network features a maximum temperature of more than 100° C. The relatively high energy density resulting therefrom is more than sufficient to implement the common partial processes in the brewhouse facility, in particular the mashing process and the wort boiling process.

The maximum temperature of the heat transfer means in the second energy supply network preferably should be in the temperature range between 75° C. and 99° C., in particular in the temperature range between 85° C. and 95° C. At this temperature level of the heat transfer means in the second energy supply network, all essential partial processes in the bottling facility, in particular the bottle cleaning process for cleaning used bottles and/or the rinsing process for rinsing the unused new bottles and/or the pasteurizing process for pasteurizing the beer filled into be bottles, can be readily implemented. By means of the temperature level in the second energy supply network being below 100° C., it is furthermore ensured that a plurality of energy generation methods, in particular alternative energy generation methods, can be employed for providing the necessary process heat.

The energy generation facility for feeding the process heat into the first energy supply network, which is assigned to the brewhouse facility, as a matter of course can be designed in the type of a conventional fossil fuel to fired thermal power plant. In order to enhance the CO₂ balance during operation of the brewery plant in view of reducing greenhouse gases, it is, however, particularly advantageous if in the energy generation facility of the first energy supply network biomass can be thermally utilized by means of gasification and/or combustion. For this purpose, biomass utilization facilities, for instance thermal power plants for combusting wood chips, are employed, which generate the necessary process heat to be fed into the first energy supply network by means of gasification and/or combustion of biomass. The CO₂ released in this process just corresponds to the amount of greenhouse gas which was previously trapped in the biomass. Since it is not necessary to satisfy the entire energy demand of the brewery plant by means of the thermal utilization of biomass, but only the amount for supplying energy to the brewhouse facility needs to be provided, biomass utilization plants of acceptable sizes and dimensions can be employed.

It is particularly advantageous if the biomass utilization plant is designed in such a manner that the spent grains resulting from the beer production in the brewhouse facility during lautering and filtering of the wort can be thermally utilized therein. As a result, it is thereby ensured that the energy generation facility for the supply of process heat to the brewhouse facility does not have to be supplied with fuel from an external source, but that the fuel, namely the spent grains, are derived from the production process per se. The special advantage in connection with the inventive principle of separating the temperature level using two separate energy supply networks can be seen in that the amount of spent grains available for the thermal utilization is in fact not sufficient for covering the entire process heat demand of the brewery plant, but is sufficient for covering the process heat demand in the brewhouse facility itself. This means that the thermal utilization process for utilizing the spent grains is suitable for supplying an amount of process heat which in terms of its energy density and in terms of its energy demand is suitable for supplying all partial processes in the brewhouse facility with process heat.

The inventive principle of separating the energy level between the brewhouse facility and the bottling facility permits the utilization of energy generation facilities in which the process heat is generated with a relatively low energy density. In particular, using the inventive principle of separating the energy level, alternative energy generation facilities for operating the brewery plant can be employed, which could previously not be used due to the relatively low energy density of the process heat produced therein. In particular, solar thermal plants, in which hot water is heated using solar energy, can be employed. The option of using geothermal plants, in which hot water is heated using geothermal heat, is also conceivable. Moreover, it is possible to make use of waste heat from other processes in the brewery plant. For this purpose, the waste heat is recovered using waste heat recovery plants and hot water is heated using the energy contained in the waste heat.

The type of waste heat to be recovered in the waste heat recovery plant is basically optional. It is particularly advantageous if in the brewery plant provision is made for a cogeneration unit which generates electricity. The waste heat from the cogeneration unit resulting from the generation of electricity then in turn can be used for heating hot water circulating as a heat transfer means in the second energy supply network. Other options for using waste heat are available if the brewery plant features a fuel cell. The fuel cell also permits the production of electrical energy, wherein the waste heat resulting from this process is fed into the second energy supply network in the form of process heat using the waste heat recovery plant. The waste heat resulting from cooling circuits of the brewery plant or the waste heat resulting from compressors of the brewery plant, as are for instance required in cooling systems for cooling, can equally be used for heating hot water and in this way for feeding process heat into the second energy supply network.

Insofar as in the brewery plant provision is made for a cogeneration unit for combined electricity and heat generation, in view of the greenhouse gas balance of the brewery this cogeneration unit preferably should be operated using biogas. In other words this means that in the cogeneration unit biogas is combusted in order to in this way generate electrical energy and process heat.

The type of biogas employed for operating the cogeneration unit is again basically optional. In order to avoid the supply of external biogas in the brewery plant provision can be made for a fermentation plant in which waste waters of the brewery plant are fermented and partially converted into biogas.

The waste water of the brewery plant in general is especially suitable for fermentation in the fermentation plant, in particular the waste water produced by squeezing wet spent grains in the squeezing unit. Insofar as the spent grains are supposed to be thermally utilized in the brewery plant in order to supply process heat to the first energy supply network, such a squeezing unit is necessary anyway, since otherwise the thermal utilization of the spent grains would not be possible at all or else only in a very restricted manner.

In order to be able to make maximum use of the resultant process heat it is particularly advantageous if excess process heat resulting from the second energy supply network, which is assigned to the bottling facility, is used for generating cooling energy. For this purpose, absorption refrigeration units can be employed, in which the process heat is converted into cooling power.

Various aspects of the invention are schematically illustrated in the drawings and are exemplarily described in the following:

In the drawings:

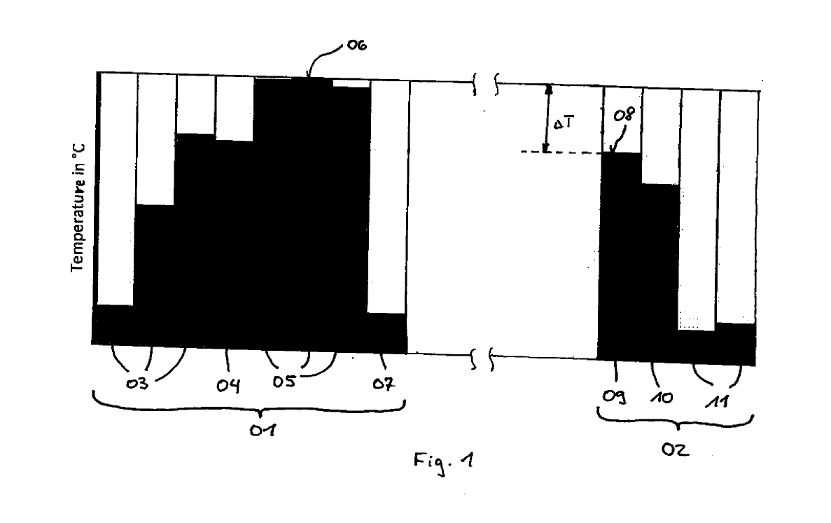

FIG. 1 shows the different temperature levels of the different partial processes in the brewhouse facility of a brewery on the one hand, and in a bottling facility of a brewery on the other hand;

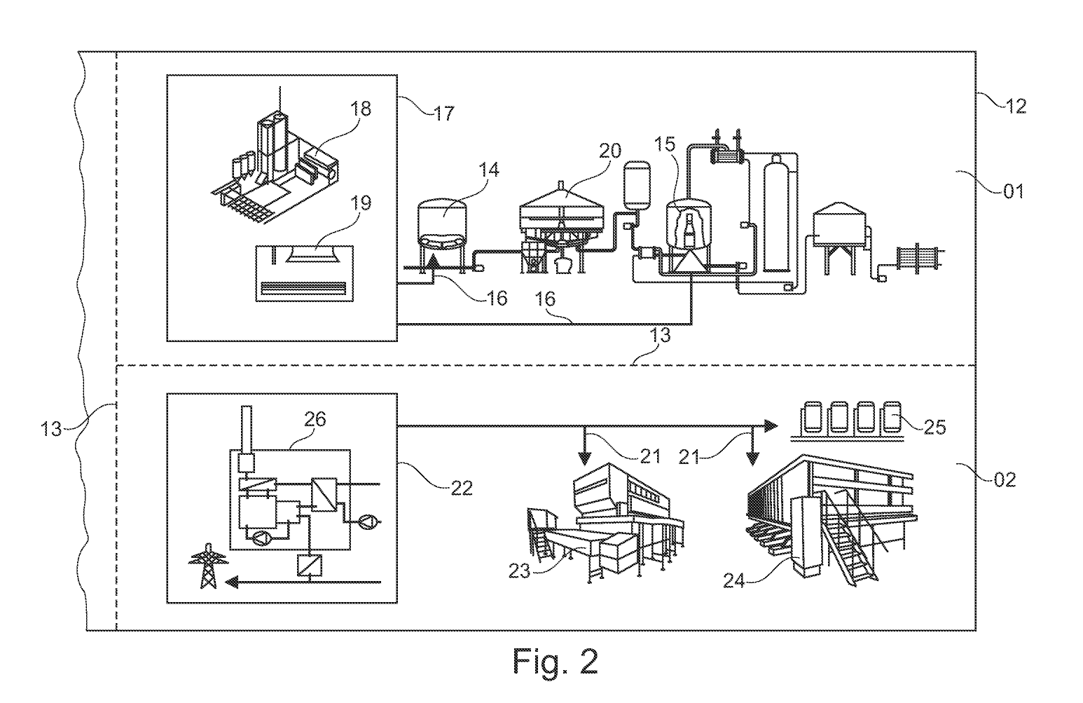

FIG. 2 schematically shows a brewery plant with the process heat supply of the brewhouse facility on the one hand, and the bottling facility on the other hand.

FIG. 1 shows the temperature levels of the partial processes in a brewhouse facility 01 on the one hand, and in a bottling facility 02 on the other hand. In the brewhouse facility 01 the wort is gradually heated to a maximum temperature level 06 during the mashing process 03, the lautering process 04 and the wort boiling process 05, and is subsequently cooled down in the wort cooling process 07. In the bottling facility 02 the maximum temperature level 08 of the bottle cleaning process 09 is determined, whereas the temperatures in the pasteurizing process 10 and in the filling process 11 are significantly lower. The differential between the maximum temperature 06 in the brewhouse facility 01 and the maximum temperature 08 in the bottling facility 02 forms the basis of the inventive brewery plant having the separate energy supply networks for supplying the brewhouse facility 01 with process heat and for supplying the bottling facility 02 with process heat.

FIG. 2 shows a schematic sectional view of a brewery plant 12 having the schematically illustrated brewhouse facility 01 and the schematically illustrated bottling facility 02. In terms of the process heat supply, the brewhouse facility 01 and the bottling facility 02 are separated from one another by a boundary 13. In order to supply the mashing vessel 14 and the wort boiling vessel 15 with the necessary process heat, provision is made for a first energy supply network 16, into which the process heat resulting from a first energy generation facility 17 is fed. In the illustrated example, a thermal power plant 19 serves as the first energy generation facility for feeding the process energy into the first energy supply network 16, wherein the spent grains resulting from the lautering process in the lautering vessel 20 can be combusted in the schematically illustrated combustion kettle 19 of the thermal power plant. In this way, hot steam or hot water can be generated with a temperature of more than 100° C. and can be distributed via the energy supply network 16 to the different partial processes in the brewhouse facility 01.

In order to supply the partial processes in the bottling facility 02 with process heat, provision is made for a second energy supply network 21, into which the process heat resulting from a second energy generation facility 22 is fed. The process heat generated in the second energy generation facility 22 is transferred via the second energy supply network 21 to the bottle cleaning unit 23, to the bottle pasteurizing unit 24 and to the CIP cleaning unit 25.

In the illustrated exemplary embodiment, a cogeneration unit 26, by means of which electrical energy can be generated and fed into the power network, serves as a second energy generation facility 22. For operating the cogeneration unit 26, biogas is combusted, which is generated by fermentation of waste waters, wherein inter alia the squeezed-out water resulting from squeezing the spent grains of the lautering vessel 20 is utilized as waste water. The waste heat resulting from the necessary cooling of the cogeneration unit 26 is fed into the different plant sections of the bottling facility 02 via the second energy supply network 21 in the form of process heat.

1. Brewery plant (12) for producing and bottling beer, comprising a brewhouse facility (01) in which wort is produced from raw materials while employing process energy, and further comprising a bottling facility (02) in which the beer produced from the wort is filled into packaging containers, in particular bottles, while employing process energy,
characterized in that
in order to supply the brewhouse facility (01) with process energy, a first energy supply network (16) is provided, into which process heat having a first temperature level is fed from at least one first energy generation facility (17) and is distributed by a heat transfer means to different energy consumers (14, 15) in the brewhouse facility (01), and in order to supply the bottling facility (02) with process heat a second energy supply network (21) is provided, into which process heat having a second temperature level is fed from at least one second energy generation facility (22) and is distributed by a heat transfer means to different energy consumers (23, 24, 25) in the bottling facility (02), wherein the maximum temperature of the heat transfer means in the first energy supply network is above the maximum temperature of the heat transfer means in the second energy supply network.

2. Brewery plant according to claim 1,
characterized in that
the maximum temperature of the heat transfer means in the first energy supply network (16) is above 100° C.

3. Brewery plant according to claim 1 or 2,
characterized in that
the mashing process and/or the wort boiling process are supplied with process heat from the first energy supply network (16), which is assigned to the brewhouse facility.

4. Brewery plant according to any of claims 1 to 3,
characterized in that
the maximum temperature of the heat transfer means in the second energy supply network (21) is in the temperature range between 75° C. and 99° C., in particular in the temperature range between 85° C. and 95° C.

5. Brewery plant according to any of claims 1 to 4,
characterized in that
the bottle cleaning process for cleaning used bottles and/or the rinsing process for rinsing unused new bottles and/or the pasteurizing process for pasteurizing the beer are supplied with process heat from the second energy supply network (21), which is assigned to the bottling facility.

6. Brewery plant according to any of claims 1 to 5,
characterized in that
an energy generation facility (17) for feeding process heat into the first energy supply network (16), which is assigned to the brewhouse facility (01), is designed in the type of a biomass utilization facility (18), in which the biomass can be thermally utilized by means of gasification and/or combustion.

7. Brewery plant according to claim 6,
characterized in that
the spent grains resulting from the wort production in the brewhouse facility (01) during the lautering or filtering of the wort can be thermally utilized in the biomass utilization facility (18) by means of gasification and/or combustion.

8. Brewery plant according to any of claims 1 to 7,
characterized in that
an energy generation facility (22) for feeding process heat into the second energy supply network (21), which is assigned to the bottling facility (02), is designed in the type of a solar thermal plant, in which hot water can be heated using solar energy, and/or in the type of a geothermal plant, in which hot water can be heated using geothermal heat, and/or in the type of a waste heat recovery plant, in which hot water can be heated using waste heat from another plant section (26).

9. Brewery plant according to claim 8,
characterized in that
in the waste heat recovery plant the waste heat from a cogeneration unit (26) of the brewery plant (12) or the waste heat from a fuel cell of the brewery plant (12) or the waste heat from a cooling circuit of the brewery plant (12) or the waste heat from a compressor of the brewery plant (12) is utilized for heating hot water.

10. Brewery plant according to claim 9,
characterized in that
in the cogeneration unit (26) of the brewery plant (12) biogas is thermally utilized for generating electricity and process heat.

11. Brewery plant according to claim 10,
characterized in that
in the cogeneration unit (26) of the brewery plant (12) biogas, which is produced in a fermentation facility by fermenting waste water of the brewery plant (12), is thermally utilized.

12. Brewery plant according to claim 11,
characterized in that
the waste water for producing the biogas in the fermentation facility is produced by squeezing the wet spent grains from the brewhouse facility (01) in a squeezing unit.

13. Brewery plant according to any of claims 1 to 12,
characterized in that
excess process heat from the second energy supply network (21), which is assigned to the bottling plant (02), can be utilized for generating cooling energy in an absorption refrigeration unit.
